(19) United States
(12) Patent Application Publication
(10) Pub. No.: US 2025/0196811 A1
(43) Pub. Date: Jun. 19, 2025

(54) WIPER ARM

(71) Applicants: DENSO WIPER SYSTEMS, INC., Kosai-shi, Shizuoka (JP); DENSO CORPORATION, Kariya-city, Aichi (JP)

(72) Inventors: Seiichi HAYAKAWA, Kazo-shi (JP); Shigeru MUTO, Kariya-city (JP)

(73) Assignees: DENSO WIPER SYSTEMS, INC., Kosai-shi, Shizuoka (JP); DENSO CORPORATION, Kariya-city, Aichi (JP)

(21) Appl. No.: 18/838,942

(22) PCT Filed: Feb. 16, 2023
(86) PCT No.: PCT/JP2023/005477

§ 371 Date: Aug. 15, 2024

(30) Foreign Application Priority Data
Feb. 17, 2022 (JP) 2022-022937

(51) Int. Cl. B60S 1/34

(52) U.S. Cl. CPC B60S 1/3429

(57) ABSTRACT

A wiper arm properly connects a retainer and an arm piece, even if a radius of curvature in a bent portion of a holding part of the retainer is set large, in the wiper arm including the arm piece connected to the retainer by accommodating and holding a held part of the arm piece within the holding part of the retainer. An arm piece includes a held part including chamfered portions disposed opposite to bent portions of a holding part of a retainer. A held part has a flat upper surface between the chamfered portions and is held within an accommodating portion of the holding part so that the upper surface abuts on a lower surface of a flat top wall of the holding part. The chamfered portions are formed so that a width of the upper surface is not larger than a width of the lower surface.

### TECHNICAL FIELD

The present invention relates to a wiper arm for use in a wiper device for a vehicle.

### BACKGROUND ART

A vehicle wiper device for use in a vehicle such as an automobile generally includes a wiper blade that wipes a wiped surface such as a glass surface of the vehicle, a wiper arm that holds the wiper blade, and a drive means (drive motor) that drives the wiper arm. The wiper arm in such a vehicle wiper device includes an arm head linked with the drive means, a retainer pivotably connected to the arm head, and an arm piece held by the retainer (see FIGS. 1 and 2). The arm piece is coupled to the wiper blade in a coupling portion of its tip, while being connected to a holding part of a retainer tip in a held part at a base end.

FIG. 4 shows such a connecting portion between the retainer and the arm piece in a cross-sectional view. As shown, a holding part 110 of the retainer includes a top wall 111 and side walls 112 and 113 on each side. A held part 120 of the arm piece is accommodated within an accommodating portion 114 surrounded by the top wall 111 and the side walls 112 and 113. By applying rolling and caulking process to the holding part 110 (side walls 112 and 113) in a state where the held part 120 is accommodated within the accommodating portion 114, the held part 120 is held within the accommodating portion 114 of the holding part 110, and the retainer and the arm piece are connected. Note that FIG. 4 shows a state before such rolling and caulking is applied to the holding part 110.

### CITATION LIST

### Patent Literature

### [Patent Literature 1]

Japanese Patent Laid-Open No. 2020-163956

### SUMMARY OF INVENTION

### Technical Problem to be Solved by Invention

In such a wiper arm retainer, bent portions 115 and 116 curved at a predetermined curvature are formed between the top wall 111 and the side walls 112 and 113 of the holding part 110. In some cases, it is necessary to change the degree of curve (curvature) of the bent portions 115 and 116. For example, if protrusions in the bent portions 115 and 116 should be reduced, it is necessary to increase the radius of curvature of the bent portions 115 and 116 (namely, to reduce the curvature so as to smooth the curve).

However, as shown by a dash-dotted line in FIG. 4, when the radius of curvature of the bent portions 115 and 116 is increased (the curve is smoothed), since the bent portions 115 and 116 have some plate thickness, the inner surfaces 115A and 116A of the bent portions 115 and 116 enter the interior of the accommodating portion 114 and interfere with the held part 120 disposed within the accommodating portion 114.

Specifically, as shown in FIG. 5, when the held part 120 is disposed within the accommodating portion 114 of the holding part 110, both side portions 122 and 123 of an upper surface 121 of the held part 120 may contact the inner surfaces 115A and 116A of the bent portions 115 and 116, respectively. As a result, a gap 130 is generated between the lower surface 111A of the top wall 111 of the holding part 110 and the upper surface 121 of the held part 120, so that the held part 120 is not correctly disposed within the accommodating portion 114 and tilts to left or right relative to the holding part 110 (tilts around the longitudinal axis of the held part 120 of the arm piece). When caulking is performed in a state where a posture of the held part 120 is collapsed in this way, the arm piece is connected to the retainer in a twisted state, and a holding force for fixing the arm piece (held part 120) to the retainer (holding part 110) decreases. This causes a problem that a wiping performance of the wiper device is degraded.

The present invention has been made in view of such problems, and it is an object of the present invention to provide a wiper arm capable of properly connecting a retainer and an arm piece, even if a radius of curvature in a bent portion of a holding part of the retainer is set large, in the wiper arm including the arm piece connected to the retainer by accommodating and holding the held part of the arm piece within the holding part of the retainer.

### Solution to Problem

The present invention provides a wiper arm including an arm piece, and a retainer to which the arm piece is connected, wherein the arm piece includes a held part connected to the retainer, wherein the retainer includes a holding part that accommodates and holds the held part of the arm piece, wherein the holding part of the retainer includes a bent portion curved at a predetermined curvature, and wherein the held part of the arm piece includes a chamfered portion opposite to the bent portion of the retainer when accommodated within the holding part.

The holding part of the retainer may include a top wall and side walls on the opposite sides of the top wall, and the bent portion may be formed between the top wall and each of the side walls.

The top wall of the holding part of the retainer may include a flat lower surface disposed opposite to the held part, the held part of the arm piece may include a flat upper surface disposed opposite to the top wall, and the lower surface of the top wall of the holding part may abut on the upper surface of the held part.

The upper surface of the held part may have a width that is not larger than a width of the lower surface of the top wall of the holding part.

The width of the upper surface of the held part may be equal to the width of the lower surface of the top wall of the holding part.

The held part may be held on the holding part by rolling and caulking the holding part around the held part in a state where the held part is accommodated within the holding part.

### Advantageous Effects of Invention

According to the present invention, in a wiper arm (for example, wiper arm 1) that accommodates and holds a held part (for example, held part 22) of an arm piece (for example, arm piece 20) in a holding part (for example, holding part 12) of a retainer (for example, retainer 10), the held part includes a chamfered portion (for example, chamfered portions 26, 27) opposite to a bent portion (for example, bent portions 16, 17) of the holding part. Therefore, a proper gap (a gap capable of avoiding contact of the bent portions with both side portions (corner portions) of an upper surface of the held part) is formed between the bent portion and the chamfered portion. Thus, even if a curve (radius of curvature) of the bent portion is increased, the bent portion is inhibited from interfering with the held part. Accordingly, the held part can be held in a proper posture without tilting within the holding part, and it is therefore possible to prevent the arm piece from twisting relative to the retainer. Therefore, since the arm piece is connected in a proper posture to the retainer, a wiper blade connected to the wiper arm is also disposed in a proper posture with respect to a surface to be wiped, and it is possible to secure a high wiping performance of the wiper blade. In addition, the chamfered portion can be easily formed by, for example, surface pushing (pressing), so that when the radius of curvature of a bent portion of a retainer of a wiper arm need to be increased, it is possible to easily modify a conventional wiper arm at low cost simply by making a minimal change to the arm piece.

When the present invention is applied to a wiper arm including a bent portion formed between a top wall (for example, top wall 13) of a holding part of a retainer and each of side walls on the opposite sides (for example, side walls 14 and 15), the radius of curvature of the bent portion can be properly increased while maintaining the high wiping performance, and a bent shape between the top wall and the side wall can be properly smoothed.

When a flat upper surface (for example, upper surface 23) of the held part abuts on a flat lower surface (for example, lower surface 13A) of the top wall of the holding part, this abutment properly regulates an angle of the held part relative to the holding part, and it is therefore possible to hold the held part in a correct posture without tilting in the holding part.

When the upper surface of the held part has a width that is not larger than a width of the lower surface of the top wall of the holding part, the upper surface of the held part can be properly received within the lower surface of the top wall. Therefore, the whole upper surface of the held part is completely in abutment with the lower surface of the top wall, and the tilting of the held part can be securely prevented.

When the width of the upper surface of the held part is equal to the width of the lower surface of the top wall of the holding part, a contact area between the upper surface and the lower surface of the top wall can be maximized, and stability of the posture of the held part within the holding part can be enhanced.

When the present invention is applied to a wiper arm including the held part held on the holding part by rolling and caulking the holding part around the held part in a state where the held part is accommodated within the holding part, the held part does not tilt relative to the holding part and can keep the correct posture during the rolling and caulking process of the holding part.

### BRIEF DESCRIPTION OF DRAWINGS

FIG. 1 is a perspective view showing a wiper arm in an embodiment of the present invention.

FIG. 2 is a plan view also showing the wiper arm.

FIG. 3 is a cross-sectional view of the wiper arm along line A-A of FIG. 2.

FIG. 4 is a cross-sectional view showing a connecting portion between a retainer and an arm piece in a conventional wiper arm.

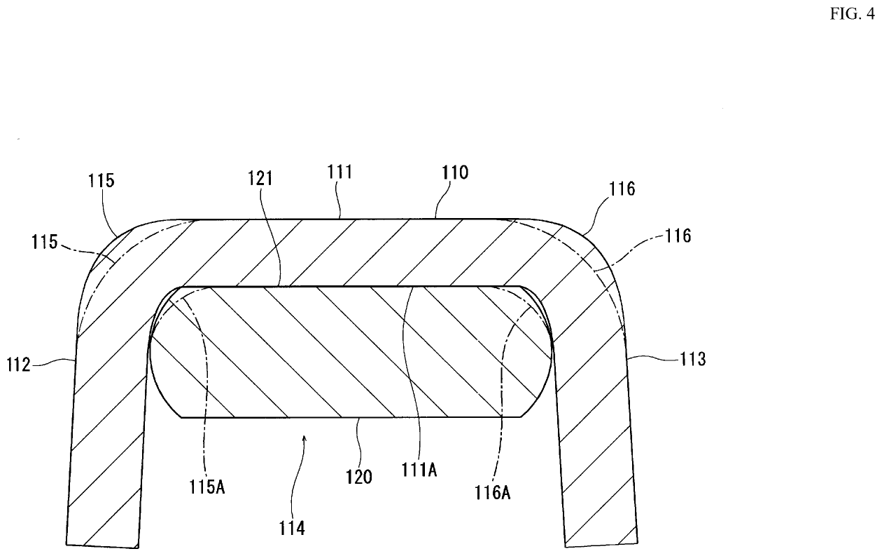

FIG. 5 is a cross-sectional view showing the connecting portion between the retainer and the arm piece in the conventional wiper arm, in a case where a radius of curvature in a bent portion of a holding part of the retainer is increased.

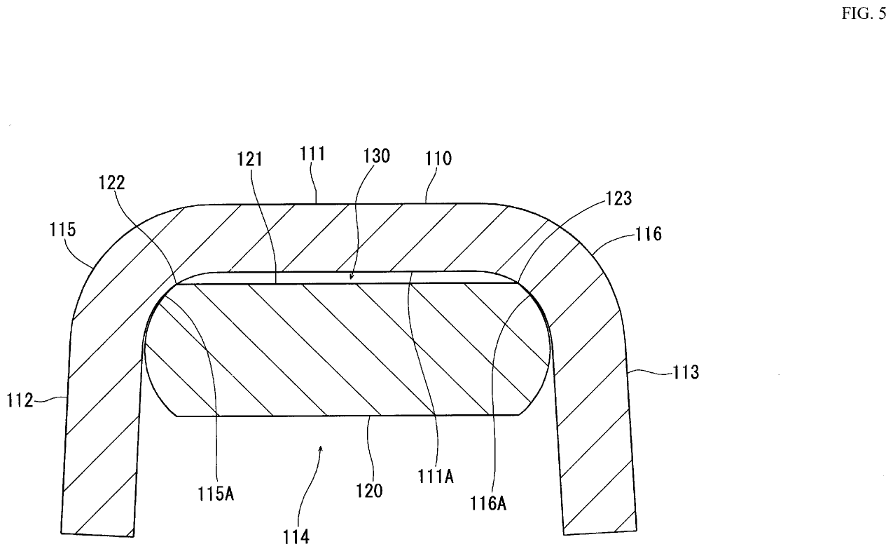

### DESCRIPTION OF EMBODIMENT

Hereinafter, an embodiment of the present invention will be described with reference to the accompanying drawings.

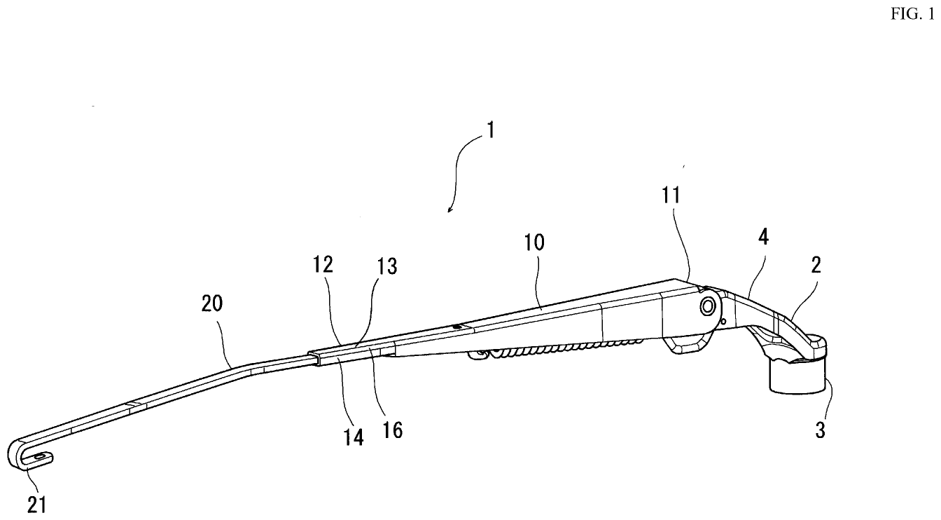

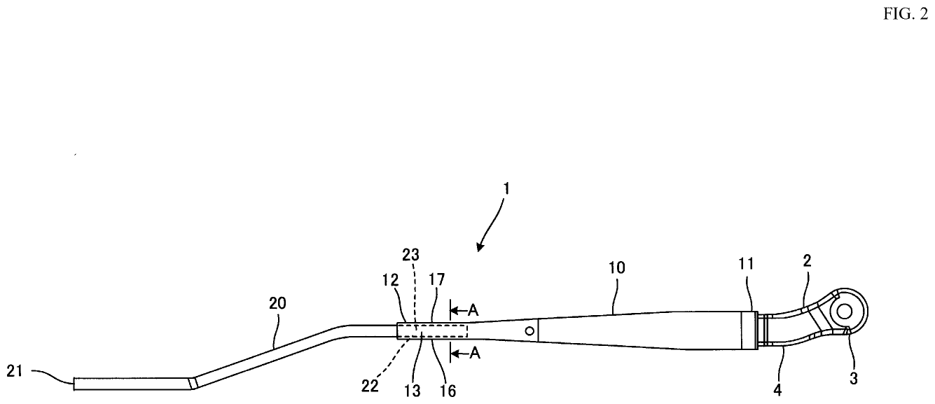

FIGS. 1 and 2 show an overall configuration of a wiper arm 1 in an embodiment of the present invention. As shown in the drawings, the wiper arm 1 includes an arm head 2, a retainer 10 pivotably connected to the arm head 2, and an arm piece 20 connected to the retainer 10.

The arm head 2 is a member constituting the base end side of the wiper arm 1 and includes a base 3 connected to a drive means (not shown) and an arm portion 4 extending from the base 3. The retainer 10 is a long member constituting a middle part of the wiper arm 1, made of, for example, a metal, and pivotably connected to the arm portion 4 of the arm head 2 at a base end 11. Meanwhile, the tip portion of the retainer 10 constitutes a holding part 12 connected to a held part 22 at a base end of the arm piece 20.

The arm piece 20 is a long member constituting the tip side of the wiper arm 1, and made of, for example, a metal. The tip portion of the arm piece 20 constitutes a U-hook part 21 bent into a hook shape. The U-hook part 21 is coupled to a coupling portion of a wiper blade (not shown) so that the wiper blade is coupled to the wiper arm 1.

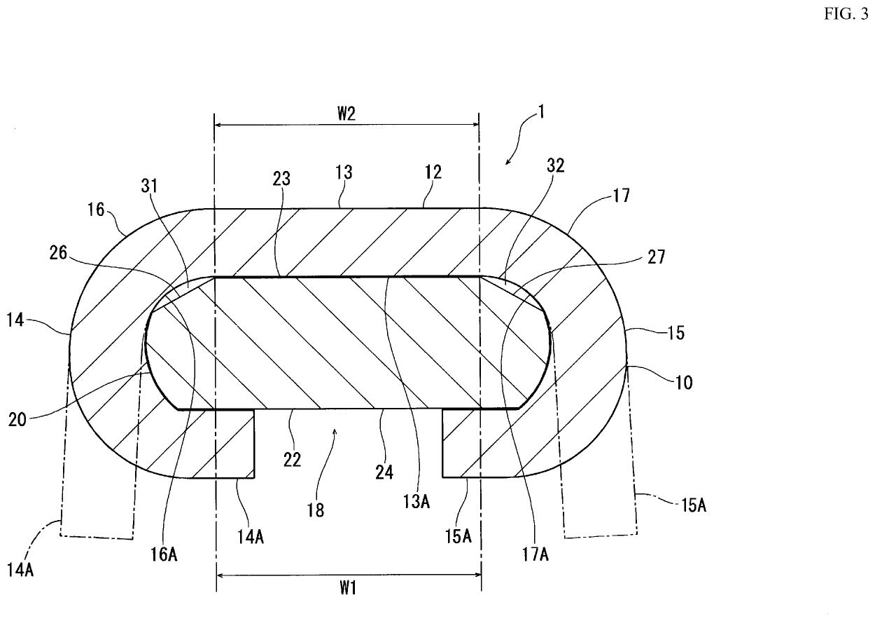

As shown also in FIG. 3, the holding part 12 of the retainer 10 is a member having a U-shaped cross section and includes a top wall 13, and side walls 14 and 15 bent and extending downward from both left and right sides of the top wall 13, respectively. The top wall 13 is the part constituting the upper portion of the holding part 12 and having a flat plate shape, and includes a lower surface 13A that is a flat surface. Between the top wall 13 and the side walls 14 and 15, bent portions 16 and 17 curved at a predetermined curvature are formed.

A space surrounded by the top wall 13 and the opposing side walls 14 and 15 is an accommodating portion 18 that accommodates the held part 22 of the arm piece 20. In a state where the held part 22 is accommodated within the accommodating portion 18, rolling and caulking process is applied to the holding part 12 (side walls 14 and 15 on the opposite sides) of the retainer 10 (more specifically, rolling and caulking process is carried out so that the held part 22 is enclosed by the side walls 14 and 15 disposed on the opposite sides of the holding part 12 of the retainer 10). Accordingly, the side walls 14 and 15 of the opposite sides deform from a state shown by a dash-dotted line in FIG. 3 to a state shown by a solid line so that lower ends 14A and 15A of the side walls 14 and 15 wrap around a lower surface 24 side of the held part 22 and abut on the lower surface 24, and the held part 22 is held within the holding part 12.

The held part 22 of the arm piece 20 includes a flat upper surface 23. When the held part 22 is accommodated within the accommodating portion 18 of the holding part 12, the upper surface 23 of the held part 22 is disposed opposite to the lower surface 13A of the top wall 13 of the holding part 12.

On both left and right sides of the upper surface 23 of the held part 22, chamfered portions 26 and 27 are formed. When the held part 22 is accommodated within the accommodating portion 18 of the holding part 12, the chamfered portions 26 and 27 are arranged opposite to inner surfaces 16A and 17A of the bent portions 16 and 17 of the holding part 12. With such a configuration, when the held part 22 is assembled to the holding part 12, gaps 31 and 32 are obtained between the chamfered portions 26, 27 and the inner surfaces 16A, 17A of the bent portions 16, 17.

Therefore, even if the bent portions 16 and 17 are formed in a curved shape having a large radius of curvature, it is possible to prevent both side portions of the upper surface 23 of the held part 22 (both sides (both corners) constituting boundary portions between both side surfaces of the held part 22 and the upper surface 23) from contacting the inner surfaces 16A and 17A of the bent portions 16 and 17. Therefore, the upper surface 23 of the held part 22 is properly in abutment with the lower surface 13A of the top wall 13 of the holding part 12, and the held part 22 is held in the correct posture without tilting relative to the holding part 12. Consequently, the arm piece 20 is properly connected to the retainer 10 without twisting.

The chamfered portions 26 and 27 are formed as flat inclined surfaces which are inclined downward from both the left and right sides of the upper surface 23 of the held part 22 (both sides in the direction which is perpendicular to the longitudinal axis of the held part 22 and extends along the upper surface 23). Note that the shape of the chamfered portions 26 and 27 is not limited to the inclined surface as exemplified in the present embodiment, and any shape can be adopted as long as the gaps 31 and 32 can be obtained between the chamfered portions 26, 27 and the inner surfaces 16A, 17A of the bent portions 16, 17.

The chamfered portions 26 and 27 are formed so that a width W1 (width between the chamfered portions 26 and 27) of the upper surface 23 of the held part 22 is not larger than a width W2 (width between the bent portions 16 and 17) of the lower surface 13A of the top wall 13 of the holding part 12. Namely, in a transverse cross section of each location of the holding part 12 and held part 22 in a longitudinal direction, the width W1 of the upper surface 23 is less than or equal to the width W2 of the lower surface 13A. Consequently, the entire upper surface 23 is properly received within the lower surface 13A of the top wall 13, and the entire upper surface 23 can completely abut on the lower surface 13A.

Particularly, in the present embodiment, the width W1 of the upper surface 23 of the held part 22 is set equal to the width W2 of the lower surface 13A of the top wall 13 of the holding part 12. As a result, a contact area between the upper surface 23 and the lower surface 13A of the top wall 13 can be maximized, and therefore the stability of the posture of the held part 22 relative to the holding part 12 can be enhanced.

The chamfered portions 26 and 27 can be formed, for example, by surface pushing (pressing) applied to both side portions of the upper surface 23 of the held part 22. Therefore, when changing the curvature of the bent portions 16 and 17, the chamfered portions 26 and 27 having a proper shape and size can be easily formed simply by performing the surface pressing on the held part of the conventional arm piece 20.

The chamfered portions 26 and 27 of the held part 22 are provided over an entire length of the held part 22 in the longitudinal direction (direction perpendicular to paper surface in FIG. 3). However, the present invention is not limited to such a form. If the curvature of the bent portions 16 and 17 varies at each location in the longitudinal direction of the holding part 12, the presence or absence and size of the chamfered portions 26 and 27 in the held part 22 may be determined in correspondence with the curvature of the opposing bent portions 16 and 17. For example, if the radius of curvature is large only in a portion of the bent portions 16 and 17 of the holding part 12 in the longitudinal direction, the held part 22 may be provided with the chamfered portions 26 and 27 only in a portion opposed to the portion where the radius of curvature is large.

As described above, according to the wiper arm 1 of the present embodiment, the chamfered portions 26 and 27 are provided on both the side portions of the upper surface 23 of the held part 22 of the arm piece 20, and the chamfered portions 26 and 27 are arranged opposite to the inner surfaces 16A and 17A of the bent portions 16 and 17 of the holding part 12 of the retainer 10. Therefore, the proper gaps 31 and 32 are formed between the chamfered portions 26, 27 and the inner surfaces 16A, 17A of the bent portions 16, 17 to avoid contact between the inner surfaces 16A, 17A of the bent portions 16, 17 and both the side portions of the upper surface 23.

Therefore, even if the radius of curvature (curve) of the bent portions 16 and 17 is set large, the held part 22 can be inhibited from interfering with the inner surfaces 16A and 17A of the bent portions 16 and 17 of the holding part 12, which makes it possible to dispose the held part 22 in the proper posture without tilting within the accommodating portion 18 of the holding part 12. In other words, the held part 22 is inhibited from tilting lower on one of the left and right sides as viewed from the longitudinal direction. Therefore, since twisting of the arm piece 20 relative to the retainer 10 can be properly prevented, the wiper blade coupled to the arm piece 20 of the wiper arm 1 is disposed at a desired angle as designed, and a high wiping performance by the wiper blade can be secured.

In addition, the width W1 (that is, the width between the chamfered portions 26 and 27) of the upper surface 23 of the held part 22 is set not to be larger than the width W2 (that is, the width between the bent portions 16 and 17) of the lower surface 13A of the top wall 13 of the holding part 12. Consequently, the entire upper surface 23 can be disposed and received within the lower surface 13A of the top wall 13, and the entire upper surface 23 of the held part 22 can contact the lower surface 13A of the top wall 13. Therefore, the holding part 12 is caulked in a state where the flat surfaces of the upper surface 23 and the lower surface 13A of the top wall 13 are in abutment with each other, and therefore the held part 22 is assembled in the correct posture without tilting with respect to the holding part 12.

Furthermore, particularly, if the width W1 of the upper surface 23 of the held part 22 is set equal to the width W2 of the top wall 13 of the holding part 12, the contact area between the upper surface 23 and the lower surface 13A of the top wall 13 can be maximized, and therefore the stability of the posture of the held part 22 relative to the holding part 12 can be maximized.

### INDUSTRIAL APPLICABILITY

The present invention can be utilized for a wiper arm of a wiper device for a vehicle such as an automobile.

### LIST OF REFERENCE NUMERALS

1 wiper arm
2 arm head
3 base of arm head
4 arm portion of arm head
10 retainer
11 base end of retainer
12 holding part of retainer
13 top wall of holding part
13A lower surface of top wall
14 side wall of holding part
14A lower end of side wall
15 side wall of holding part
15A lower end of side wall
16 bent portion of holding part
17 bent portion of holding part
18 accommodating portion of holding part
20 arm piece
21 U-hook part
22 held part of arm piece
23 upper surface of held part
24 lower surface of held part
26 chamfered portion of held part
27 chamfered portion of held part

1. A wiper arm comprising an arm piece, and a retainer to which the arm piece is connected,
wherein the arm piece includes a held part connected to the retainer,
wherein the retainer includes a holding part that accommodates and holds the held part of the arm piece,
wherein the holding part of the retainer includes a bent portion curved at a predetermined curvature, and
wherein the held part of the arm piece includes a chamfered portion opposite to the bent portion of the retainer when accommodated within the holding part.

2. The wiper arm according to claim 1, wherein the holding part of the retainer includes a top wall and side walls disposed on the opposite sides of the top wall, and
wherein the bent portion is formed between the top wall and each of the side walls.

3. The wiper arm according to claim 2, wherein the top wall of the holding part of the retainer includes a flat lower surface disposed opposite to the held part,
wherein the held part of the arm piece includes a flat upper surface disposed opposite to the top wall, and
wherein the lower surface of the top wall of the holding part abuts on the upper surface of the held part.

4. The wiper arm according to claim 3, wherein the upper surface of the held part has a width that is not larger than a width of the lower surface of the top wall of the holding part.

5. The wiper arm according to claim 4, wherein the width of the upper surface of the held part is equal to the width of the lower surface of the top wall of the holding part.

6. The wiper arm according to claim 1, wherein the held part is held on the holding part by rolling and caulking the holding part around the held part in a state where the held part is accommodated within the holding part.

7. The wiper arm according to claim 2, wherein the held part is held on the holding part by rolling and caulking the holding part around the held part in a state where the held part is accommodated within the holding part.

8. The wiper arm according to claim 3, wherein the held part is held on the holding part by rolling and caulking the holding part around the held part in a state where the held part is accommodated within the holding part.

9. The wiper arm according to claim 4, wherein the held part is held on the holding part by rolling and caulking the holding part around the held part in a state where the held part is accommodated within the holding part.

10. The wiper arm according to claim 5, wherein the held part is held on the holding part by rolling and caulking the holding part around the held part in a state where the held part is accommodated within the holding part.
